(19) United States
(12) Patent Application Publication
(10) Pub. No.: US 2001/0043262 A1
(43) Pub. Date: Nov. 22, 2001

(54) OPTICAL WRITING DEVICE OBTAINING A CONSTANT AMOUNT OF PASS-THROUGH LIGHT

(76) Inventors: TSUKASA YAGI, KOBE-SHI (JP); ISAO DOI, OSAKA (JP); KEN MATSUBARA, OSAKA (JP)

Correspondence Address: MCDERMOTT WILL & EMERY, 600 13TH STREET, N.W., WASHINGTON, DC, 20005-3096, US

(21) Appl. No.: 09/393,295

(22) Filed: Sep. 10, 1999

(30) Foreign Application Priority Data
Sep. 11, 1998 (JP) 10-258299

(51) Int. Cl. B41J 2/435

(52) U.S. Cl. 347/237

(57) ABSTRACT

Disclosed is an optical writing device comprising a plurality of writing light shutter elements and at least one of monitoring light shutter element. Both the writing and monitoring light shutter elements are driven by being alternatively impressed a forward electric field and a reverse electric field with a predetermined impression ratio of the forward and reverse electric fields during optical writing operation. After the optical writing operation, the monitoring light shutter element is driven by being impressed the forward electric field with varying the amount of the electric field, whereby a half-wavelength voltage of the monitoring light shutter element is determined. For the next optical writing operation, the impression ratio is updated based on the determined half-wavelength voltage.

This application is based on application No.HEI 10-258299 filed in Japan, the entire content of which is hereby incorporated by reference.

### BACKGROUND OF THE INVENTION

1. Field of the Invention

The present invention pertains to an optical writing device that writes or displays images on an image receptor surface, and more particularly to an optical writing device that uses an electro-optical material such as PLZT for its light shutter elements.

2. Description of the Related Art

An image forming apparatus that forms images (latent images) by exposing photographic paper or film using a silver photosensitive material or a photosensitive unit for electronic photography by means of an optical writing device is conventionally known. One solid-state scanning type form of this optical writing device, in which a PLZT light shutter element array is used, is known. In an optical writing device of this solid-state scanning type, a polarizer and an analyzer are located in the upstream area and the downstream area of the light path, respectively, relative to the light shutter element array. The polarizer and the analyzer are arranged in a Cross-Nicoled fashion relative to the light shutter elements. Because PLZT is a material that has an electro-optical effect, as is publicly known, light may be allowed to pass through or prevented from passing through each light shutter element by controlling the applied voltage. FIG. 8 shows the relationship between the drive voltage for each light shutter element and the amount of pass-through light. The curved line A represents the characteristic in the initial stage, and the amount of pass-through light reaches the maximum level when a half-wavelength voltage V_{H} is applied. The light shutter elements are usually driven using a voltage close to the half-length voltage V_{H}.

Incidentally, the light shutter element has a common electrode formed on one side and an individual electrode formed on the other side. Light is made to pass through the light shutter element by grounding the common electrode and impressing voltage to the individual electrode (creating a forward electric field) in response to image data. Conversely, the light shutter element may be driven by grounding the individual electrode and applying voltage to the common electrode (creating a reverse electric field).

In the conventional light shutter device, when the light shutter elements are continuously driven by means of a forward or reverse electric field, the hysteresis phenomenon occurs, shifting the half-wavelength voltage V_{H}, and the problem occurs that the amount of pass-through light decreases. For example, the initial characteristic shown using the curved line A in FIG. 8 changes to the curved line −B after one hour of driving and to the curved line −C after 10 hours of driving. Consequently, the half-wavelength voltage V_{H} shifts by amounts ΔV_{-B} and ΔV_{-C}, and the pass-through light amount falls by ΔI_{-B} and ΔI_{-C}, respectively.

FIG. 9 is an example in which the relationship between the impressed voltage and the pass-through light amount is measured for both a forward electric field (plus side) and a reverse electric field (minus side). Curved line A is the measurement in the initial state, and has essentially the same half-wavelength voltage in both the forward (plus side) and reverse (minus side) cases. Curved lines −B and −C show the same measurement after the continuous application of a forward electric field (plus side). Where a forward electric field is applied, the curved lines shift to the minus side as operation of the light shutter elements continues over time. Therefore, curved line −C represents longer operation than curved line −B.

Next, curved lines +B and +C show measurement after the continuous application of a reverse electric field (minus side). In this case, contrary to the situation when a forward electric field is applied, the curved lines shift to the plus side as operation continues over time, and the amount of this shift increases over time as before.

As described above, the half-wavelength shift amount becomes larger as the driving time increases. Ordinarily, when optical writing is being performed, light shutter elements are driven in response to the image data, and the amount of time that voltage is applied varies for each light shutter element. In the conventional device, only a forward electric field is impressed, such that the amount of pass-through light falls for light shutter elements that are frequently driven, resulting in larger variations in the light amount in the main scanning directions (the directions in which the light shutter elements are aligned).

Consequently, the applicant of the present invention proposed a drive method in which the direction of the impressed electric field is reversed each time a prescribed optical writing cycle has elapsed. However, it has been found that the shift in the half-wavelength voltage cannot be completely eliminated even if the direction of the impressed electric field is alternated equally between forward and reverse electric fields. FIG. 10 shows that the half-wavelength voltage shifts by ΔV_{C} even where the electric field is alternated between forward and reverse each time a prescribed optical writing cycle elapses during the driving of the optical writing device. The reasons for this are unclear, but are thought to be due to variations or processing errors in the PLZT chips themselves.

### SUMMARY OF THE INVENTION

Accordingly, the object of the present invention is to provide an improved optical writing device. Another object of the present invention is to provide an optical writing device in which the amount of shift in the half-wavelength voltage is reduced to the minimum level and a constant amount of light can always be obtained.

In order to achieve these objects, the optical writing device pertaining to the present invention has light shutter elements used for optical writing that are made of an electro-optical material and are aligned in the main scanning direction, at least one monitoring light shutter element that is made of the electro-optical material and is separate from the writing light shutter elements, a driving unit that impresses forward and reverse electric field to the writing and monitoring light shutter elements while optical writing is being performed, a measuring unit that measures the half-wavelength voltage by impressing an electric field to the at least one monitoring light shutter element while no optical writing is being performed, and a control unit that determines the ratio for the impression of a forward electric field and a reverse electric field during optical writing based on the results of the measurement by the measuring unit.

In the present invention, an electric field is applied to the at least one monitoring light shutter element while optical writing is taken place, said electric field being alternated between forward and reverse. That is, the direction of the electric field application is reversed each time a prescribed optical writing cycle elapses in order to prevent the occurrence of hysteresis. Furthermore, in the present invention, the half-wavelength voltage regarding the monitoring light shutter elements is measured while optical writing is not being performed, and the result of the measurement is fed back for the determination of the ratio for the impression of a forward electric field and a reverse electric field for the next printing session. That is, by correcting the ratio for the impression of a forward electric field and a reverse electric field at prescribed points in time, hysteresis may be further reduced, the reduction in light amount may be prevented to the extent possible during continuous driving, and high-quality images may be obtained over a long period of time.

These and other objects, advantages and features of the invention will become apparent from the following description thereof taken in conjunction with the accompanying drawings which illustrates a specific embodiment of the invention.

### BRIEF DESCRIPTION OF DRAWINGS

FIG. 1 shows the basic construction of a light shutter device, one embodiment of the present invention, and its control unit.

FIG. 2 is a block diagram showing the driving circuit of a light shutter module.

FIG. 3 is a block diagram showing the high voltage driver and the common electrode driving circuit in said driving circuit.

FIG. 4 is a timing chart showing the operation of said driving circuit.

FIG. 5 is a graph to explain the measurement of the half-wavelength voltage regarding the light shutter element.

FIG. 6 is a flow chart showing a first control method.

FIG. 7 is a flow chart showing a second control method.

FIG. 8 is graphs showing the relationship between the driving voltage and the amount of pass-through light regarding the light shutter element.

FIG. 9 is graphs showing the relationship between the driving voltage and the amount of pass-through light regarding the light shutter element.

FIG. 10 is graphs showing the shift of the half-wavelength voltage when the forward and reverse electric fields impressed to the light shutter element are alternated on a 50/50 basis.

### DETAILED DESCRIPTION OF THE PREFERRED EMBODIMENTS

The embodiments of the light shutter device pertaining to the present invention are explained below with reference to the accompanying drawings.

### Overall Construction

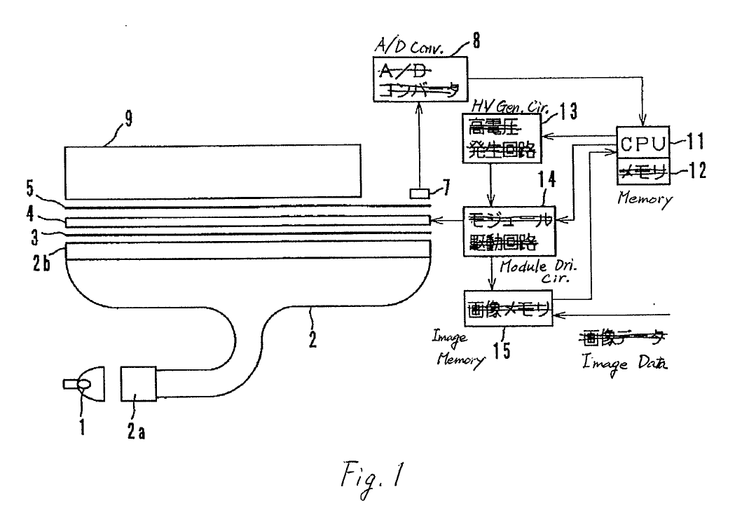

First, FIG. 1 shows the construction of the main components of an electrophotographic image forming apparatus in which a print head comprising one embodiment of the optical writing device pertaining to the present invention is applied.

This image forming apparatus has a print head that writes images (latent images) on the photoreceptor drum 9. The print head essentially includes a light source (halogen lamp) 1, an optical fiber array 2, a polarizer 3, a light shutter module 4 and an analyzer 5. The optical fiber array 2 comprises a number of optical fibers bound together. Light from the light source 1 enters the fiber array 2 via the light entry end 2a and exits from it in a linear fashion via the light exit end 2b. The polarizer 3 and the analyzer 5 are located in a Cross-Nicoled fashion relative to the light shutter elements of the light shutter module, such that each plane of polarization is angled 45° relative to the direction of the electric field impressed to the light shutter elements.

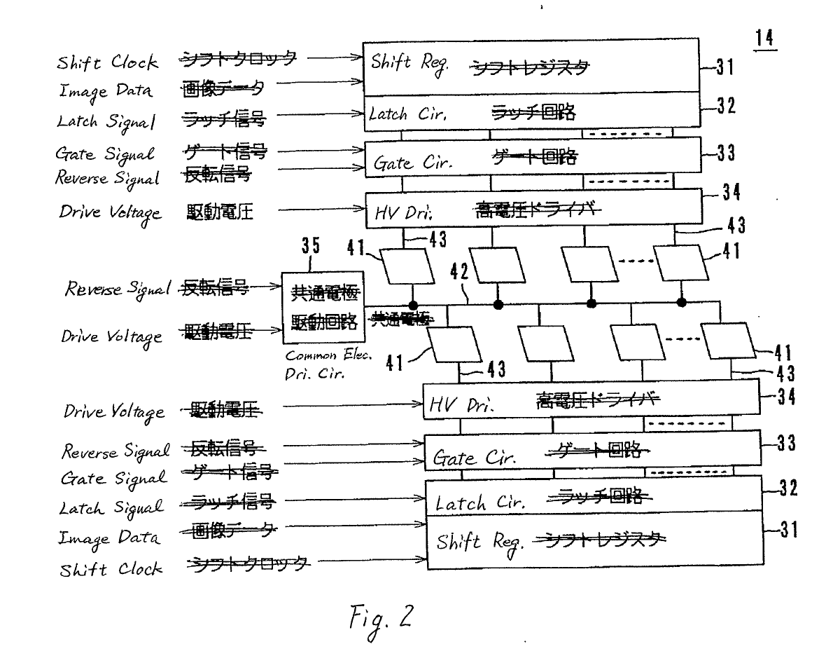

The light shutter module 4 comprises a glass substrate or a ceramic substrate having a slit opening and multiple light shutter chips that are made of PLZT and are placed on the substrate. Each of the light shutter chips has multiple light shutter elements, each of which corresponds to one pixel during optical writing. As shown in FIG. 2, the light shutter elements 41 are arranged in two asymmetrical rows such that the elements are arranged in a zigzag fashion and the two rows of light shutter elements together form an image corresponding to one line in the main scanning directions. PLZT, as it is publicly known, comprises a light-permeable ceramic material having an electro-optical effect with a large Kerr constant. The light that undergoes linear polarization by the polarizer 3 experiences rotation of the plane of polarization when a voltage is applied to the light shutter element 41, and exits through the analyzer 5. When no voltage is applied, the plane of polarization does not rotate and the pass-through light, which did not undergo rotation of the plane of polarization, is cut off by the analyzer 5.

In other words, as the application of a voltage to the light shutter element is turned ON and OFF, the light pass-through property is also turned ON and OFF. The light that exits the analyzer 5 forms an image on the photoreceptor drum 9 via the image forming lens not shown in the drawings, resulting in the formation of an electrostatic latent image on the drum 9. The light shutter elements are turned ON and OFF one line at a time in accordance with the image data (main scanning). By synchronizing the main scanning and the speed of rotation of the photoreceptor drum 9 in one direction (secondary scanning), a two-dimensional image (latent image) is formed on the drum 9.

Further, in this embodiment, monitoring light shutter element is located next to one end of the array of light shutter elements used for optical writing, which is described above, where the monitoring light shutter element does not irradiate the photoreceptor drum 9. The amount of pass-through light from these monitoring light shutter elements is detected by a photosensor 7. The details of this detection are described below.

### Controller

The optical writing device of this embodiment includes a controller having as its central component a CPU 11 equipped with a memory 12, as shown in FIG. 1. This controller essentially comprises the CPU 11, a high-voltage generating circuit 13, a module driving circuit 14 and an image memory 15. The memory 12 includes a random access memory (RAM), which functions as the CPU 11's work area, and a non-volatile memory such as a flash memory, which can be overwritten. The controller also includes an A/D converter that converts the light amount (expressed as an analog value) detected by the photosensor 7 into a digital value. The digitally converted data that indicates the detected light amount is then input to the CPU 11.

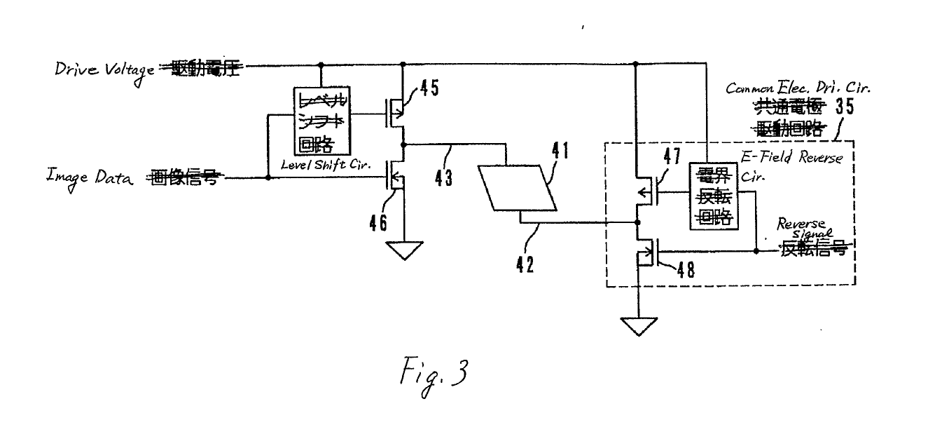

The details of the module driving circuit 14 are shown in FIG. 2. The circuit comprises shift registers 31, latch circuits 32, gate circuits 33, high-voltage drivers 34, and a common electrode driving circuit 35. The individual electrodes 43 of light shutter elements 41 are connected to either one of the high-voltage drivers 34, and the common electrode 42 is grounded via the common electrode driving circuit 35. The high-voltage driver 34 and the common electrode driving circuit 35 have two pairs of switching elements 45, 46 and 47, 48, as shown in FIG. 3. When the elements 45, 46 are ON, a forward electric field is impressed to the light shutter elements 41. On the other hand, when the elements 46, 47 are ON, a reverse electric field is impressed to the light shutter elements 41.

Referring to FIG. 2, the image data for one line is transferred to the shift registers 31 in synchronization with a shift clock and is then latched to the latch circuits 32 when a latch signal is ON. The image data is transferred to the high-voltage drivers 34 without undergoing processing when a gate signal is ON, if the reverse signal is OFF. If a reverse signal is ON, the image data is reversed and transferred to the high-voltage drivers 34. When no field reversal occurs, the high-voltage driver 34 output a drive voltage to the individual electrodes 43, and when field reversal takes place, it grounds the individual electrodes 43. On the other hand, the common electrode driving circuit 35 grounds the common electrode 42 when no field reversal takes place, and outputs a drive voltage to the common electrode 42 when field reversal is performed.

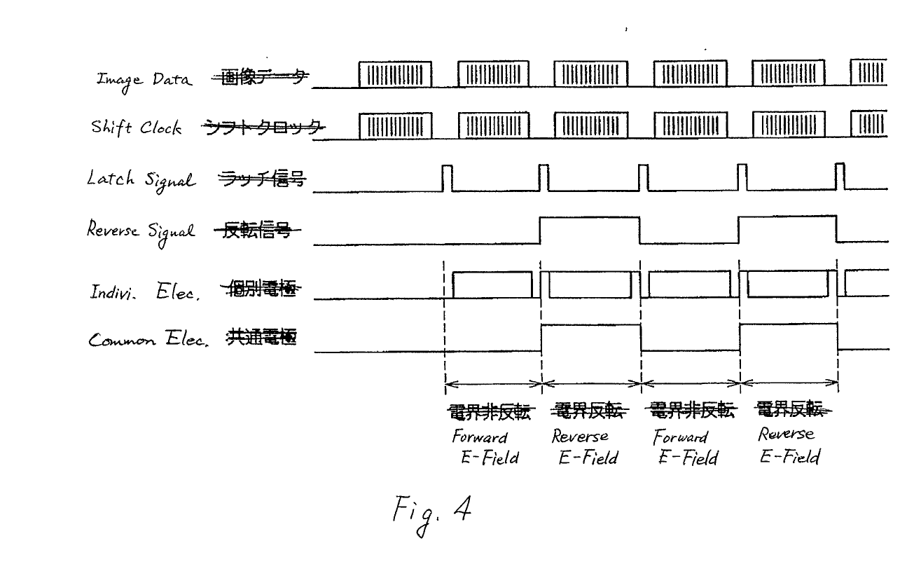

FIG. 4 is a timing chart showing the operation described above. As is clear from this chart, the reverse signal is alternated ON and OFF each time optical writing is performed for one line. The timing chart of FIG. 4 shows the ratio of the impression of a forward electric field and a reverse electric field (hereinafter simply the ‘impression ratio’) to be 50/50. Usually, the shift of the half-wavelength voltage regarding the light shutter elements may be controlled to some extent by alternating the direction of electric field impression using this ratio. However, in this embodiment, the impression ratio is adjusted such that the amount of shift may be further reduced and the reduction in the amount of pass-through light may be further reduced during continuous driving.

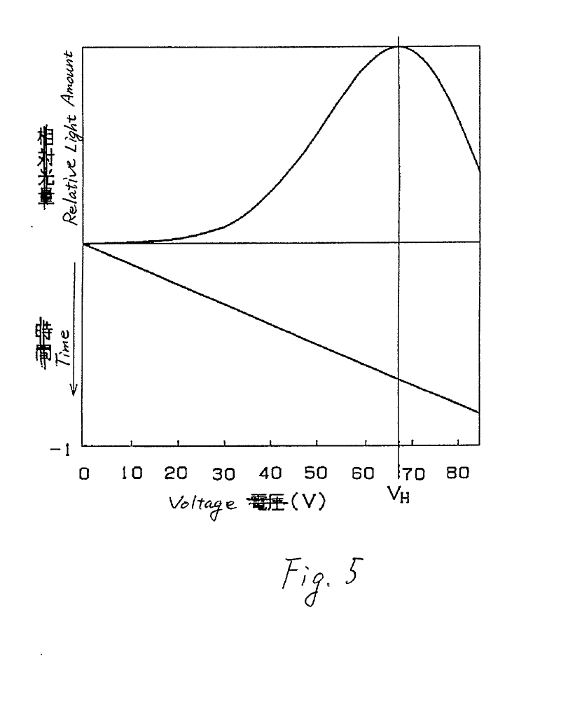

The high-voltage generating circuit 13 generates a voltage based on an instruction from the CPU 11, and the voltage thus generated is impressed to the light shutter elements. When optical writing is performed, the writing light shutter elements are driven using a prescribed impression ratio and based on the image data. At the same time, the monitoring light shutter element is driven on a continuous basis using the same impression ratio as used for the writing light shutter elements. When printing onto a prescribed number of sheets is completed, the monitoring light shutter elements are driven while the impressed voltage is varied on a continuous basis from 0 volts to a level exceeding the half-wavelength voltage. The amount of light exiting from the monitoring light shutter element that was obtained when the monitoring light shutter element was driven with varying voltage is detected by the photosensor 7. The amount of light detected is shown inn FIG. 5. The voltage at which the largest amount of light is obtained during the measurement is the half-wavelength voltage. The common electrode is grounded and measurement is taken to obtain the half-wavelength voltage when a forward electric field is applied, and then the individual electrodes are grounded and measurement is performed when a reverse electric field is applied.

### Control Methods

First and second methods are available as control methods to measure the half-wavelength voltage regarding the monitoring light shutter element and feed back said voltage for determination of the impression ratio for the next optical writing session.

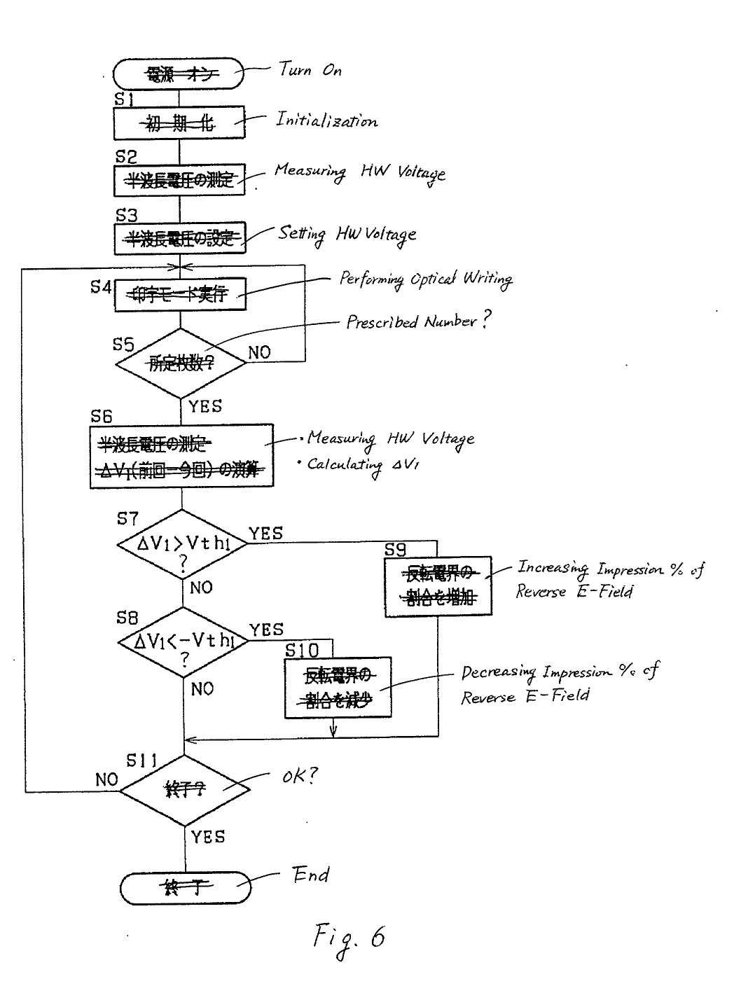

### First Control Method: FIG. 6

In the first control method, either one of a forward electric field or a reverse electric field is impressed to the monitoring light shutter element, and the impression ratio for the next printing session is determined based on the difference ΔV₁ between the half-wavelength voltage measured this time and the half-wavelength voltage measured previously.

That is, as shown in FIG. 6, when power is turned ON, prescribed initialization is taken place in step S1. In step S2, the monitoring light shutter element is turned ON with varying applied voltage and the half-wavelength voltage is measured. The voltage level thus measured is set in the high-voltage generating circuit 13 in step S3. The impression ratio is set to be 50/50 in the initialization of step S1. However, it is only when power is turned ON to the apparatus for the first time that the impression ratio is set to be 50/50. If the previous ratio is stored in the memory 12, that ratio is set in the high voltage generating circuit 13 instead.

In step S4, optical writing is performed based on the image data. When this occurs, the light shutter elements are driven with the direction of the impressed electric field being alternated using the initially set ratio. The writing light shutter elements are driven based on the image data and the monitoring light shutter element is driven continuously throughout the printing session. When optical writing is completed, it is determined in step S5 whether or not the number of sheets printed has reached the prescribed number, and each time the prescribed number is reached, the following corrective steps S6 through S10 are executed.

In step S6, the half-wavelength voltage regarding the monitoring light shutter element is measured, and the difference ΔV₁ between the half-wavelength voltage previously measured and stored in the memory 12 and the half-wavelength voltage measured this time is calculated. In steps S7 and S8, the half-wavelength voltage difference ΔV₁ is compared with the threshold values Vₜₕ₁ and −Vₜₕ₁. The threshold values Vₜₕ₁ and −Vₜₕ₁ are prescribed values used as standards for changing the impression ratio for the next optical writing session, and should be in the range between 0.1 to 1 volts.

Where the half-wavelength voltage difference ΔV₁ is larger than Vₜₕ₁ (YES in step S7), i.e., where the amount of shift in the half-wavelength voltage is in excess of the threshold value Vₜₕ₁ to the minus side, the percentage of impression of the reverse electric field is increased by a certain amount in step S9. On the other hand, where the half-wavelength voltage difference ΔV₁ is smaller than −Vₜₕ₁ (YES in step S8), i.e., where the amount of shift in the half-wavelength voltage is in excess of the threshold −Vₜₕ₁ to the plus side, the percentage of impression of the reverse electric field is decreased by a certain amount in step S10. Where the half-wavelength voltage difference ΔV1 is between Vₜₕ₁ and −Vₜₕ₁, the impression ratio is not changed. The amount by which the impression ratio is increased or decreased in steps S9 or S10 varies depending on the characteristics of the light shutter device itself and the frequency of measurement, but it might be around 1 to 5 percent.

As described above, the half-wavelength voltage data set in step S3 and the impression ratio data determined in steps S9 or S10 are stored in the memory 12. The data is read from the memory 12 when optical writing is performed in step S4 and the light shutter elements are driven. The impression ratio is updated each time a prescribed number of sheets is printed, such that the reduction in light amount during continuous driving is prevented to the extent possible.

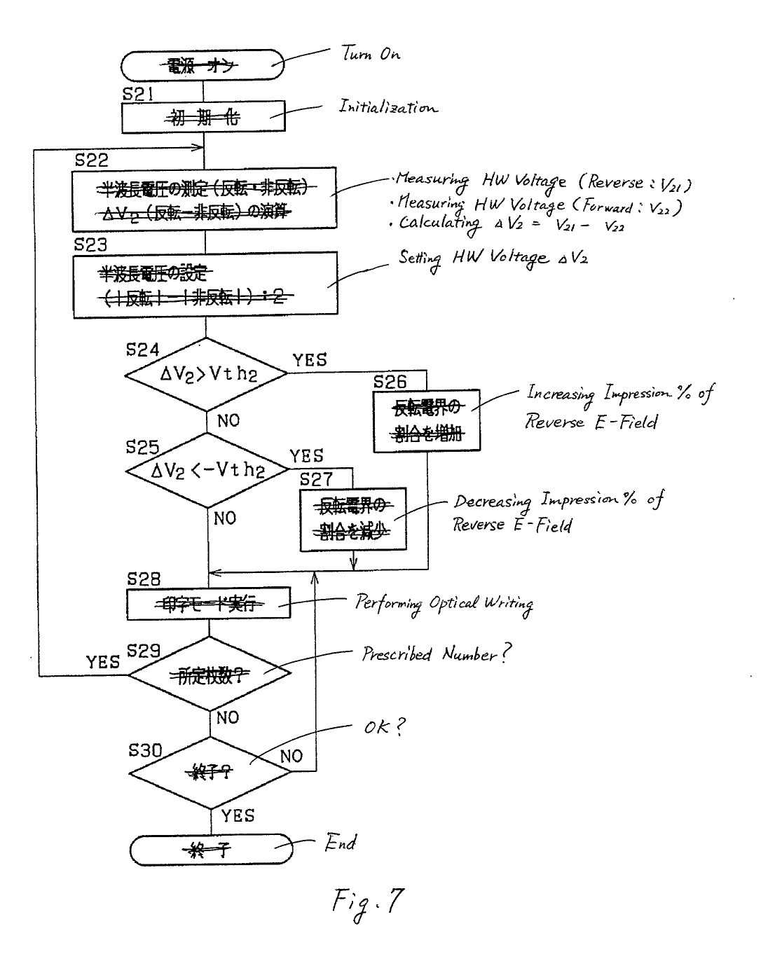

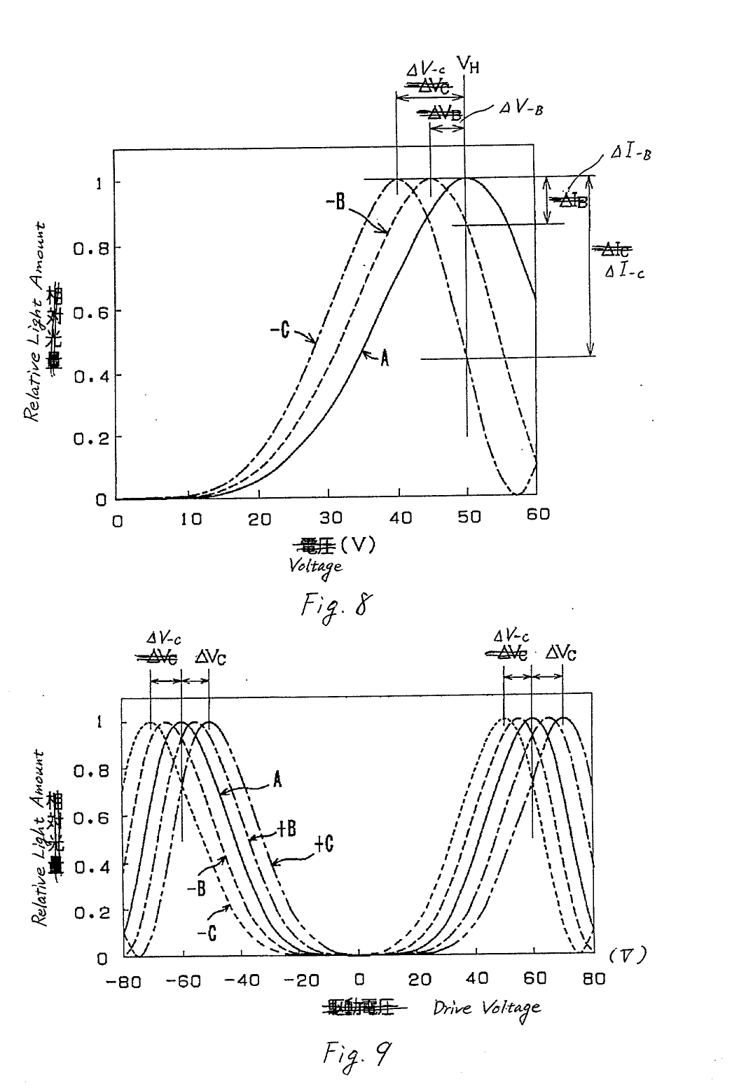

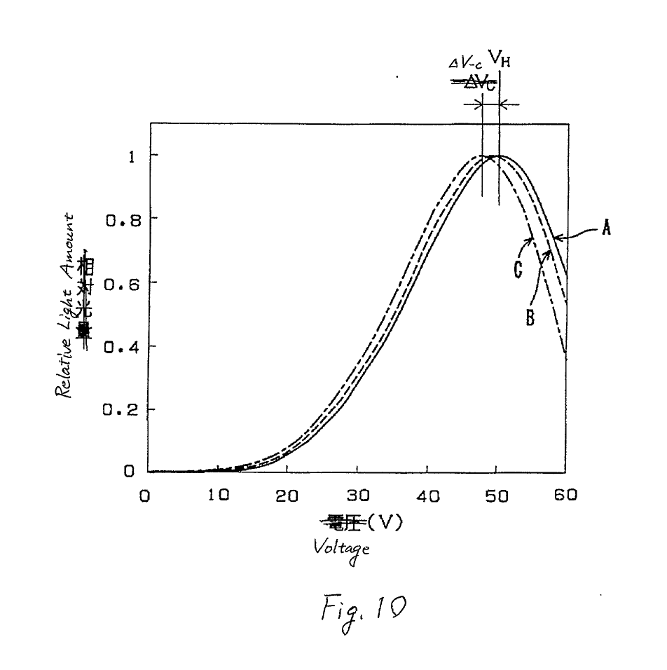

### Second Control Method: FIG. 7

In the second control method, both a forward electric field and a reverse electric field are impressed to the monitoring light shutter element, and the impression ratio for the subsequent optical writing session is determined based on the difference ΔV₂ between the half-wavelength voltages occurring when the two respective electric fields are impressed.

That is, as shown in FIG. 7, when power is turned ON, in step S21, prescribed initialization is performed. This initialization is identical to that performed in step S1, and the impression ratio is also set either to 50/50 or to the previous ratio stored in the memory 12.

Next, in step S22, the half-wavelength voltage regarding the monitoring light shutter element is measured when both a forward electric field and a reverse electric field are applied, and the difference ΔV₂ between the two half-wavelength voltages is calculated. In step S23, the midpoint value between said half-wavelength voltages is set in the high-voltage generating circuit 13. In steps S24 and S25, the half-wavelength voltage difference ΔV₂ is compared with the threshold values Vₜₕ₂ and −Vₜₕ₂. Where the difference ΔV₂ is larger than Vₜₕ₂ (YES in step S24), i.e., where the half-wavelength voltage has shifted to the minus side, the percentage of impression of the reverse electric field is increased by a certain amount in step S26. On the other hand, where the difference ΔV₂ is smaller than Vₜₕ₂ (YES in step S25), i.e., where the half-wavelength voltage has shifted to the plus side, the percentage of impression of the reverse electric field is decreased by a certain amount in step S27. If the difference ΔV₂ is between Vₜₕ₂ and −Vₜₕ₂, the impression ratio does not change.

As described above, the data regarding the half-wavelength voltage measured in step S23 and the data regarding the impression ratio determined in steps S26 and S27 are stored in the memory 12. During the optical writing performed in the next step S28, this data is read out and the light shutter elements are driven. In step S29, the processes of steps S22 through S27 are carried out each time it is determined that the printing of a prescribed number of sheets has been completed, and these data values are updated, whereby a reduction in the amount of light during continuous driving is eliminated to the extent possible.

The threshold values Vₜₕ₂ and −Vₜₕ₂ and the percentage variation of the reverse electric field impression are determined based on the same standards as in the first control method. The threshold values Vₜₕ₂ and −Vₜₕ₂ should fall within the range of 0.1 to 1.0 volts, and the percentage variation might be 1 to 5 percent.

### Other Embodiments

The optical shutter device pertaining to the present invention is not limited to the embodiments described above, and may be changed in various ways within its essential scope. For example, the optical writing device is not limited to a device that exposes a photoreceptor, and may, for example, comprise a device that projects an image onto a screen.

Furthermore, the construction for detecting the half-wavelength voltage of the monitoring light shutter element and the control methods shown in FIGS. 6 and 7 may be freely selected.

Moreover, in the above mentioned embodiments, although the sensor directly sensing light amount outputted from the monitoring light shutter element is employed, the sensor may senses a proxy of the light amount. In particular, an electrometer can be employed as the sensor in a case where the image forming apparatus employs an electrophotographic system, and an electrical surface potential can be sensed by the electrometer as a proxy of the light amount from the monitoring light shutter element. Further more, as an alternative of the above, a photocoupler can be provided as the sensor, and a density of developed image (e.g., toner image) on an image receptor surface can be sensed by the photocoupler as a proxy of the light amount from the monitoring light shutter element.

Although the present invention has been fully described by way of examples with reference to the accompanying drawings, it is to be noted that various changes and modifications will be apparent to those skilled in the art. Therefore, unless such changes and modifications depart from the scope of the present invention, they should be constructed as being included therein.

What is claimed is:

1. An optical writing device comprising:
a plurality of writing light shutter elements used for optical writing, said writing light shutter elements being made of an electro-optical material and are aligned in a main scanning direction;
at least one monitoring light shutter element which is made of the electro-optical material and is separate from the writing light shutter elements;
a driving unit which drives said writing light shutter elements and said monitoring light shutter element, said driver being capable of impressing a forward electric field and a reverse electric field to said writing light shutter elements and said monitoring light shutter element;
measuring means for controlling said driver to impress at least one of the forward and reverse electric fields to said at least one monitoring light shutter element, and for measuring a half-wavelength voltage of said monitoring light shutter element impressed at least one of the forward and reverse electric fields; and
controlling means for determining an impression ratio of the forward electric field and the reverse electric field based on the measuring result of said measuring means.

2. The optical writing device as claimed in claim 1, wherein said writing light shutter elements and said at least one monitoring light shutter element form an array extending in a direction parallel to said main scanning direction.

3. The optical writing device as claimed in claim 2, wherein said at least one monitoring light shutter element is provided at one end of said array with respect to said main scanning direction.

4. The optical writing device as claimed in claim 1, wherein said measuring means measures the half-wavelength voltage of said monitoring light shutter element while no optical writing by said writing light shutter elements is performed.

5. The optical writing device as claimed in claim 1, wherein said measuring means controls said driver to impress the at least one of the forward and reverse electric fields with varying amount of the impressing electric field.

6. The optical writing device as claimed in claim 5, wherein said measuring means controls said driver to impress one of the forward and reverse electric fields, and then to impress the remaining one of the forward and reverse electric fields.

7. The optical writing device as claimed in claim 1, wherein said measuring means comprises a sensor sensing a light amount outputted from said at least one monitoring light shutter element, and wherein said measuring means determines the half-wavelength based on the sensed light amount.

8. The optical writing device as claimed in claim 7, wherein said sensor directly senses the light amount.

9. A method for driving a light shutter element which is driven by being applied an electric field thereto, the method comprising the steps of:
(a) driving said light shutter element by alternatively impressing a first electric field of a first direction and a second electric field of a second direction with an impression ratio of first and second electric fields, said first direction and said second direction being different;
(b) measuring, after the execution of the step (a), a half-wavelength voltage of said light shutter element, and
(c) updating the new impression ratio based on the measuring result of the step (b).

10. The method as claimed in claim 9, wherein the step (b) comprises:
(b-1) driving said light shutter element by impressing the first electric field with varying intensity of the first electric field; and
(b-1) sensing a light amount outputted from said light shutter element.

11. The method as claimed in claim 9, wherein the step (c) comprises:
(c-1) comparing the measuring result of the step (b) and a reference data; and
(c-2) updating the impression ratio based on the comparing result of step (c-1).

12. The method as claimed in claim 9, further comprising:
(d) driving said light shutter element by alternatively impressing the first and second electric fields with the impression ratio updated in the step (c).

13. The method as claimed in claim 12, further comprising:
(e) repeating the steps (a) through (d).
